(19) United States
(12) Patent Application Publication
(10) Pub. No.: US 2012/0117367 A1
(43) Pub. Date: May 10, 2012

(54) ELECTRONIC APPARATUS AND BOOTING METHOD THEREOF

(75) Inventors: Ying-Chih Lu, Taipei City (TW); Hsing-Yi Chen, Taipei City (TW)

(73) Assignee: INVENTEC CORPORATION, Taipei City (TW)

(21) Appl. No.: 12/982,817

(22) Filed: Dec. 30, 2010

(30) Foreign Application Priority Data
Nov. 8, 2010 (TW) 99138369

(51) Int. Cl. G06F 9/06

(52) U.S. Cl. 713/2

(57) ABSTRACT

An electronic apparatus and a booting method thereof are provided. First boot partition information of the electronic apparatus recorded at previous booting is obtained. Second boot partition information at current booting is obtained. Next, the first boot partition information and the second boot partition information are compared, so as to update the first boot partition information with a changed entry. Thereafter, a boot order is decided according to the updated first boot partition information.

### CROSS-REFERENCE TO RELATED APPLICATION

This application claims the priority benefit of Taiwan application serial no. 99138369, filed on Nov. 8, 2010. The entirety of the above-mentioned patent application is hereby incorporated by reference herein and made a part of this specification.

### BACKGROUND OF THE INVENTION

1. Field of the Invention

The present invention generally relates to a booting method, in particular, to a booting method and an electronic apparatus capable of automatically detecting change of disk configuration.

2. Description of Related Art

A Basic Input Output System (BIOS) plays a very important role in a computer system. When the computer system is started, the BIOS is first actuated to execute a Power On Self Test (POST), so as to initiate peripheral hardware devices. After completing the POST procedure, a boot device is selected according to a boot order.

However, if configuration of the hard disk and partitions thereof is changed, the boot device and the boot order are changed at the next booting. Currently, the changes of the hard disk and partitions thereof cannot be detected automatically, and the BIOS is informed of whether a new partition is added or whether a partition thereof is removed only in a manual manner.

For example, factors of hardware configuration change are described below. It is assumed that a hard disk is removed from the platform, and a hard disk of the same model is added to the same position of the same platform. If the removed hard disk and the newly added disk have different partitions, at this point, the system cannot automatically detect the change of the partitions. Alternatively, if the same hard disk is connected to a different position in the platform, the hard disk is considered as a different hard disk (with a changed device path). In addition, the same partition installed with different operating systems also causes change of the hardware configuration, for example, “EFI Windows 2008 OS” is changed to “Redhat Linux”, since the boot loader path and the file name are all changed. Moreover, repartitioning of the same hard disk also causes the change of the hardware configuration (the hard disk ID and the partition ID are all changed).

### SUMMARY OF THE INVENTION

Accordingly, the present invention is directed to an electronic apparatus and a booting method thereof, which are capable of automatically detecting changes of partitions to update a boot device and a boot order.

The present invention provides a booting method, which is applicable to an electronic apparatus. The booting method includes: obtaining first boot partition information of the electronic apparatus recorded at previous booting; obtaining second boot partition information of the electronic apparatus at current booting, in which the first boot partition information and second boot partition information respectively include a plurality of entries corresponding to a plurality of partitions; comparing the first boot partition information and the second boot partition information, so as to update the first boot partition information with a changed entry; and deciding a boot device and a boot order according to the updated first boot partition information.

In an embodiment of the present invention, each entry includes a partition identifier (ID), a disk ID, a disk path, and a boot loader path.

In an embodiment of the present invention, in the step of comparing the first boot partition information and the second boot partition information so as to update the first boot partition information with the changed entry, the entries of the second boot partition information may be compared one by one in terms of the partition ID, the disk ID, and the boot loader path to see whether the entries exist in the first boot partition information; and the entries of the first boot partition information may be compared one by one in terms of the partition ID, the disk ID, and the boot loader path to see whether the entries exist in the second boot partition information.

In an embodiment of the present invention, in the step of comparing the entries of the second boot partition information one by one to see whether the entries exist in the first boot partition information, when the partition ID, the disk ID, and the boot loader path of one comparison entry among the entries of the second boot partition information are all identical to those of one of the entries of the first boot partition information, it is determined that the comparison entry of the second boot partition information exists in the first boot partition information. In another aspect, when at least one of the partition ID, the disk ID, and the boot loader path of the comparison entry does not exist in the entries of the first boot partition information (or the three all do not exist in the first boot partition information), it is determined that the comparison entry of the second boot partition information does not exist in the first boot partition information.

In an embodiment of the present invention, after the step of comparing the entries of the second boot partition information one by one to see whether the entries exist in the first boot partition information, if it is determined that the comparison entry does not exist in the first boot partition information, the comparison entry is added to the first boot partition information.

In an embodiment of the present invention, in the step of comparing the entries of the first boot partition information one by one to see whether the entries exist in the second boot partition information, when the partition ID, the disk ID, the disk path, and the boot loader path of one comparison entry among the entries of the first boot partition information are all identical to those of one of the entries of the second boot partition information, it is determined that the comparison entry of the first boot partition information exists in the second boot partition information. In another aspect, when at least one of the partition ID, the disk ID, the disk path, and the boot loader path of the comparison entry does not exist in the entries of the second boot partition information (or the four all do not exist in the second boot partition information), it is determined that the comparison entry of the first boot partition information does not exist in the second boot partition information.

In an embodiment of the present invention, after the step of comparing the entries of the first boot partition information one by one to see whether the entries exist in the second boot partition information, if it is determined that the comparison entry does not exist in the second boot partition information, the comparison entry of the first boot partition information is deleted.

In an embodiment of the present invention, in the step of deciding the boot device and the boot order according to the updated first boot partition information, a boot loader table is compared with the updated first boot partition information, so as to update the boot device and the boot order. In other words, the boot loader path of each of the entries in the first boot partition information is compared to see whether the boot loader path exists in the boot loader table; and the entries with the boot loader paths existing in the boot loader table are recorded to the boot order in sequence.

In an embodiment of the present invention, the first boot partition information is stored in a parameter memory, the second boot partition information is stored in a main memory, and the boot loader table is stored in a system firmware memory.

The present invention provides an electronic apparatus, which includes a central processing unit (CPU), a chip set, a parameter memory, a main memory, and a system firmware memory. The chip set is coupled to the CPU, and the parameter memory, the main memory, and the system firmware memory are respectively coupled to the chip set. The parameter memory stores a first boot device table, and records first boot partition information of the electronic apparatus at previous booting by using the first boot device table. The main memory stores a second boot device table, and records second boot partition information of the electronic apparatus at current booting by using the second boot device table. The system firmware memory stores system firmware and a boot loader table. The CPU compares the first boot partition information and the second boot partition information by using the system firmware, so as to update the first boot partition information with a changed entry; and decides a boot device and a boot order according to the boot loader table and the updated first boot partition information.

In view of the above, any change of the disk or storage device in the present invention may be detected automatically, and the change is recorded to enable a user to know the automatically detected change, thereby updating the boot device and the boot order accordingly.

To clarify the foregoing and other objectives, features, and advantages of the present invention, a plurality of embodiments are illustrated in detail in association with the accompanying drawings in the following.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to an embodiment of the present invention.

FIG. 2 is a flow chart of a booting method according to an embodiment of the present invention.

FIG. 3 is a format chart of a GPT disk according to an embodiment of the present invention.

FIG. 4 is a schematic view of PCI architecture according to an embodiment of the present invention.

FIG. 5 is a schematic view of a boot device table according to an embodiment of the present invention.

FIG. 6 is a flow chart of a booting method according to another embodiment of the present invention.

FIG. 7 is a schematic view of a boot loader table according to an embodiment of the present invention.

FIG. 8 is a schematic view of a boot order table according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Currently, changes of a hard disk and partitions thereof in a system cannot be detected automatically, and a BIOS can only be informed of whether a new partition is added or whether a partition thereof is removed in a manual manner. Therefore, the present invention provides an electronic apparatus and a booting method thereof, so as to automatically detect the change of the partition to update the boot device and the boot order. In order to make the content of the present invention more comprehensible, embodiments are illustrated below as examples according which the present invention is implemented.

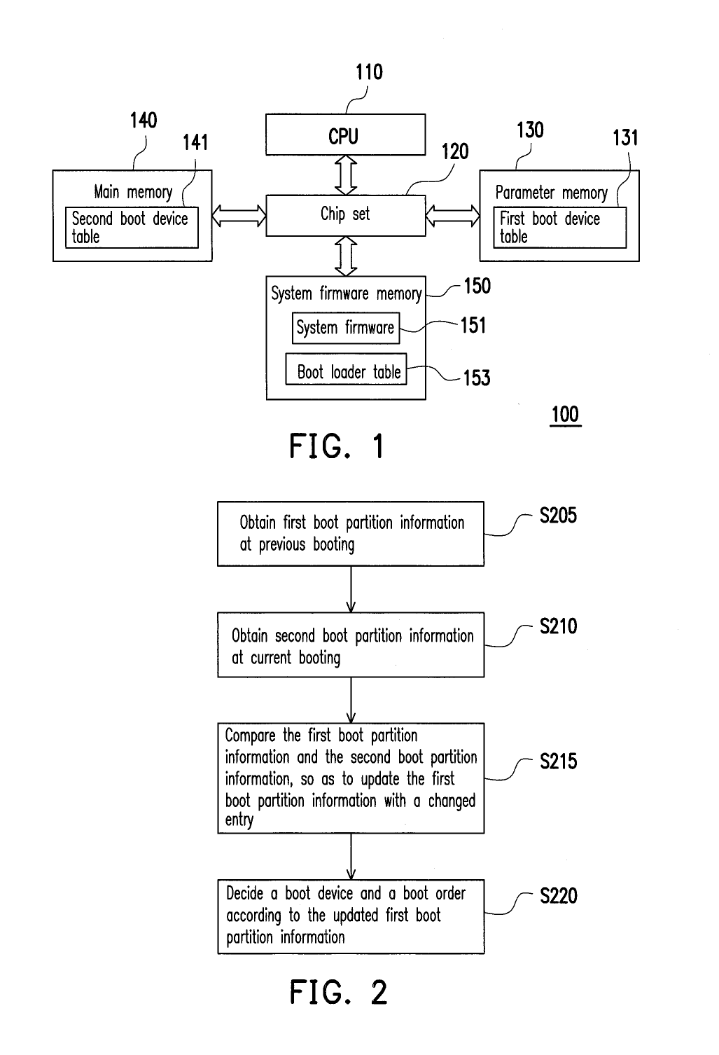

FIG. 1 is a block diagram of an electronic apparatus according to an embodiment of the present invention. Referring to FIG. 1, an electronic apparatus 100 includes a CPU 110, a chip set 120, a parameter memory 130, a main memory 140, and a system firmware memory 150. The chip set 120 is coupled to the CPU 110, and the parameter memory 130, the main memory 140, and the system firmware memory 150 are respectively coupled to the chip set 120.

The parameter memory 130 stores a first boot device table 131. The first boot device table 131 records boot partition information of the electronic apparatus 100 at previous booting (referred to as first boot partition information herein). The parameter memory 130 is, for example, a Non-volatile Random Access Memory (NVRAM), which may be an Electrically-Erasable Programmable Read-Only Memory (EEPROM).

The main memory 140 is, for example, a Random Access Memory (RAM), which stores a second boot device table 141. The second boot device table 141 records boot partition information of the electronic apparatus 100 at current booting (referred to as second boot partition information herein). The boot partition information records a plurality of entries, each entry is corresponding to a partition, and each entry records a partition identifier (ID), a disk ID, a disk path, and a boot loader path. The disk ID and the partition ID are Global Unique Identifiers (GUIDs).

The system firmware memory 150 is, for example, a Flash Read Only Memory (Flash ROM), which stores system firmware 151 (for example, BIOS) and a boot loader table 153. Herein, the boot loader table 153 records operating system index values, operating system names, and boot loader paths.

The CPU 110 compares the first boot partition information and the second boot partition information by using the system firmware 151, so as to update the first boot partition information with a changed entry. Moreover, the system firmware 151 decides a boot device and a boot order according to the boot loader table 153 and the updated first boot partition information (stored in the first boot device table 131).

Steps of the booting method are illustrated below accompanying with the electronic apparatus 100. FIG. 2 is a flow chart of a booting method according to an embodiment of the present invention. Referring to FIGS. 1 and 2, in step S205, the first boot partition information is obtained. For example, the system firmware 151 obtains the first boot partition information of the previous booting from the parameter memory 130. Then, in step S210, the second boot partition information of the electronic apparatus 100 at the current booting is obtained. For example, as for the BIOS, during a Power On Self Test (POST) procedure, the BIOS scans all disks mounted to the chip set 120 one by one, and obtains the second boot partition information from partition tables of the respectively disks. Further, the BIOS stores the second boot partition information in the second boot device table 141 of the main memory 140.

Thereafter, in step S215, the first boot partition information and the second boot partition information are compared, so as to update the first boot partition information with a changed entry. For example, the system firmware 151 is used to compare each entry in the first boot partition information to see whether the entry is identical to that in the second boot partition information. If the two are the same, it indicates that the disk configuration at this booting is identical to that at the previous booting, and therefore, the subsequent POST program may be executed directly without updating the first boot partition information. In contrast, if the first boot partition information and the second boot partition information are different, it indicates that the disk configuration at this booting is different from that at the previous booting, and the first boot partition information is updated with the changed entry.

In step S220, a boot device and a boot order are decided according to the updated first boot partition information. Specifically, the system firmware 151 is used to convert entries in the updated first boot partition information into standard Extensible Firmware Interface (EFI) variables “Boot####” (#: 0-F) and “BootOrder”, the variable “Boot####” records devices that can be booted, and the variable “BootOrder” records the boot order. The variable “Boot####” includes option data, and the disk ID and partition ID are added in the option data. The variable “BootOrder” records the order of booting.

Further, in this embodiment, the booting method is applicable to an Extensible Firmware Interface (EFI) system or a new generation Unified Extensible Firmware Interface (UEFI) system. The partition table used together with the EFI/UEFI system is a GUID Partition Table (GPT). An example is illustrated below.

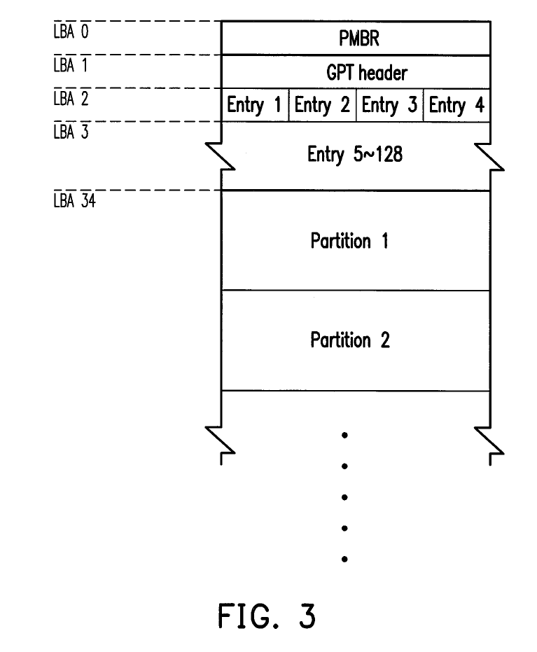

FIG. 3 is a format chart of a GPT disk according to an embodiment of the present invention. In this embodiment, the GPT disk is a disk with partitions planned through a GPT. In view of the compatibility, a first sector LBA 0 of the GPT disk still keeps a Master Boot Record (MBR).

Referring to FIG. 3, in the GPT disk, the Logic Block Address (LBA) LBA 0 stores a Protective MBR (PMBR), and an LBA 1 stores a GPT header. The GPT header includes sizes and number of entries defining available space of the disk and forming the partition table, and further records the disk GUID. LBA 2-LBA 33 store the partition table, and each entry records a partition GUID of each partition. An LBA 34 is the start of a first partition.

The boot partition information is illustrated in detail below by taking Peripheral Component Interconnect Express (PCI Express) architecture as an example. However, in other embodiments, PCI Express (PCIe) architecture or PCI-X architecture are also available.

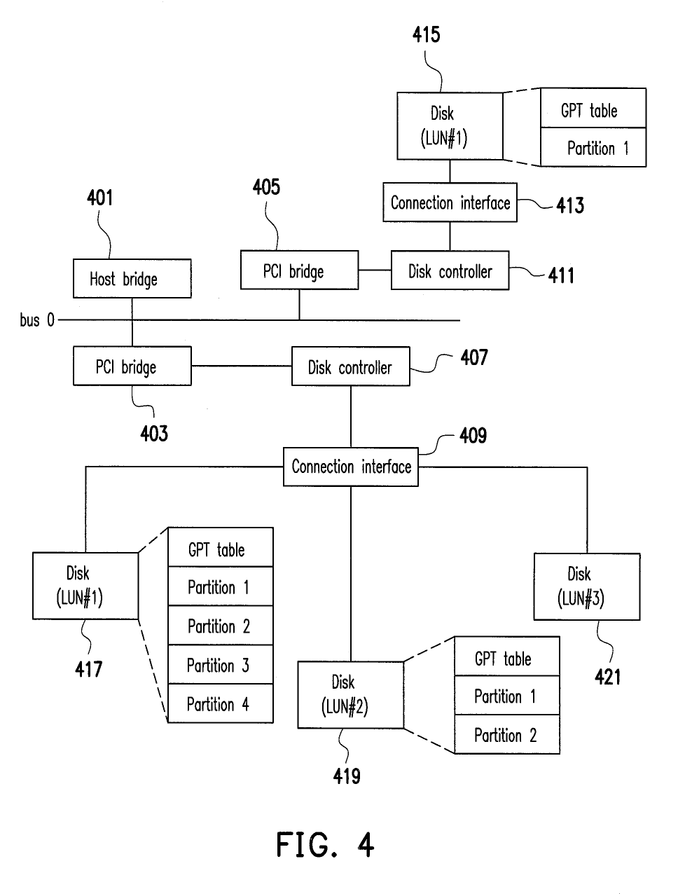

FIG. 4 is a schematic view of PCI architecture according to an embodiment of the present invention. Referring to FIG. 4, a host bridge 401 is connected to a PCI bridge 403 and a PCI bridge 405 through a bus (for example, bus 0). The PCI bridge 403 is connected to a disk controller 407, and the disk controller 407 is connected to a disk 417, a disk 419, and a disk 421 through a connection interface 409. The PCI bridge 405 is connected to a disk controller 411, and the disk controller 411 is connected to a disk 415 through a connection interface 413.

The disk controller 407 and the disk controller 411 are, for example, Small Computer System Interface (SCSI) controllers, Serial Attached SCSI (SAS) controllers, Serial Advanced Technology Attachment (SATA) controllers, Universal Serial Bus (USB) host controllers, or Internet SCSI (iSCSI) initiators. The connection interface 409 and the connection interface 413 are, for example, SCSI buses, SAS Fabrics, SATA buses, USB buses, or networks.

Logic Unit Numbers (LUNs) of the disk 417, the disk 419, and the disk 421 under the control of the disk controller 407 are respectively LUN#1, LUN#2, and LUN#3. The LUN of the disk 415 under the control of the disk controller 411 is LUN#1, and LUN indicates a code of logic disk.

In this embodiment, it is assumed that the disk 417 includes a GPT table and partitions 1-4, the disk 419 includes a GPT table and partitions 1-2, and the disk 421 has no partition. In addition, the disk 415 includes a GPT table and a partition 1. Moreover, it is assumed that the PCI bridge 403 has a device number and function number of (28,0), and the PCI bridge 405 has a device number and function number of (1,0); in addition, it is assumed that the disk controller 407 and the disk controller 411 all have a device number and function number of (0,0).

Herein, the disk path may be represented as {(bridge path), (controller position), disk number}. The bridge path is represented as (bus number, device number, function number), the controller position is represented as (device number, function number), and the disk number is the LUN.

Accordingly, the disk path of the disk 415 is {(0,1,0), (0,0), 1}, the disk path of the disk 417 is {(0,28,0), (0,0), 1}, the disk path of the disk 419 is {(0,28,0), (0,0), 2}, and the disk path of the disk 421 is {(0,28,0), (0,0), 3}.

Therefore, when the BIOS executes the POST, the BIOS scans the controllers respectively connected to the PCI bridges one by one, obtains the logic disk and the LUN value thereof from the disk connected to the PCI controller through the controller, obtains block data in the logic disk through the LUN value, and obtains the disk GUID of each disk and the partition GUID and the boot loader path of each partition from the GPT table in the block data, so as to obtain the disk path of each disk.

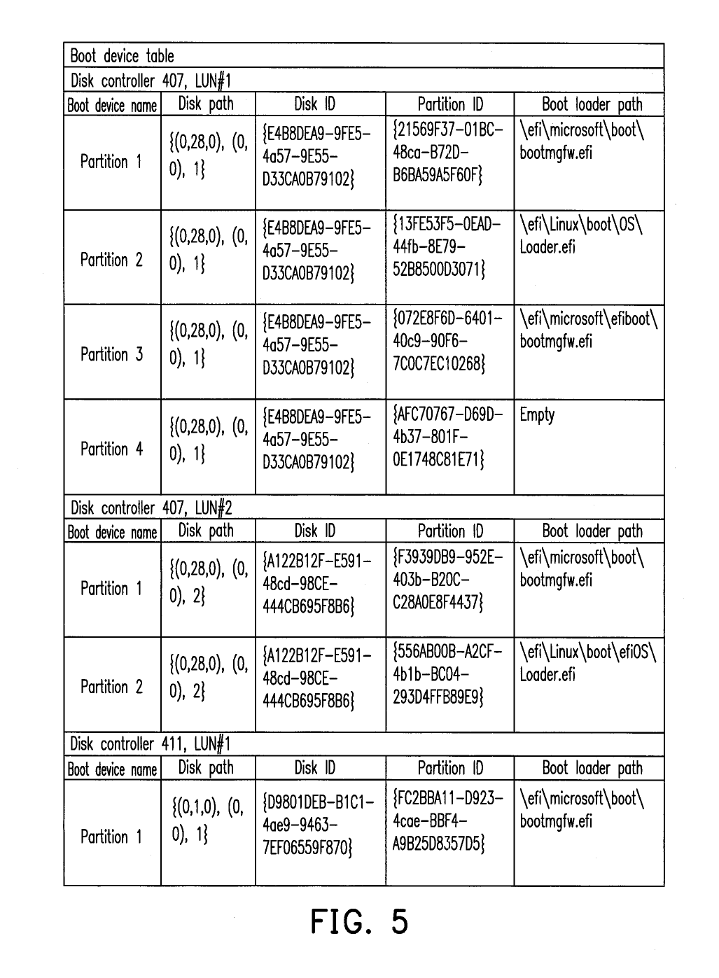

FIG. 5 is a schematic view of a boot device table according to an embodiment of the present invention. This embodiment is illustrated by taking the PCI architecture of FIG. 4 as an example. Referring to FIG. 5, the boot device table includes a boot device name field, a disk path field, a disk ID field, a partition ID field, and a boot loader path field. Herein, the disk ID and the partition ID are all GUIDs.

As for the partition 1 of the disk of LUN#1 under the control of the disk controller 407, the disk path recorded in the disk path field is {(0,28,0), (0,0), 1}, the disk ID recorded in the disk ID field is {E4B8DEA9-9FE5-4a57-9E55-D33CA0B79102}; the partition ID recorded in the partition ID field is {21569F37-01BC-48ca-B72D-B6BA59A5F60F}; and the boot loader path recorded in the boot loader path field is “\efi\microsoft\boot\bootmgfw.efi”.

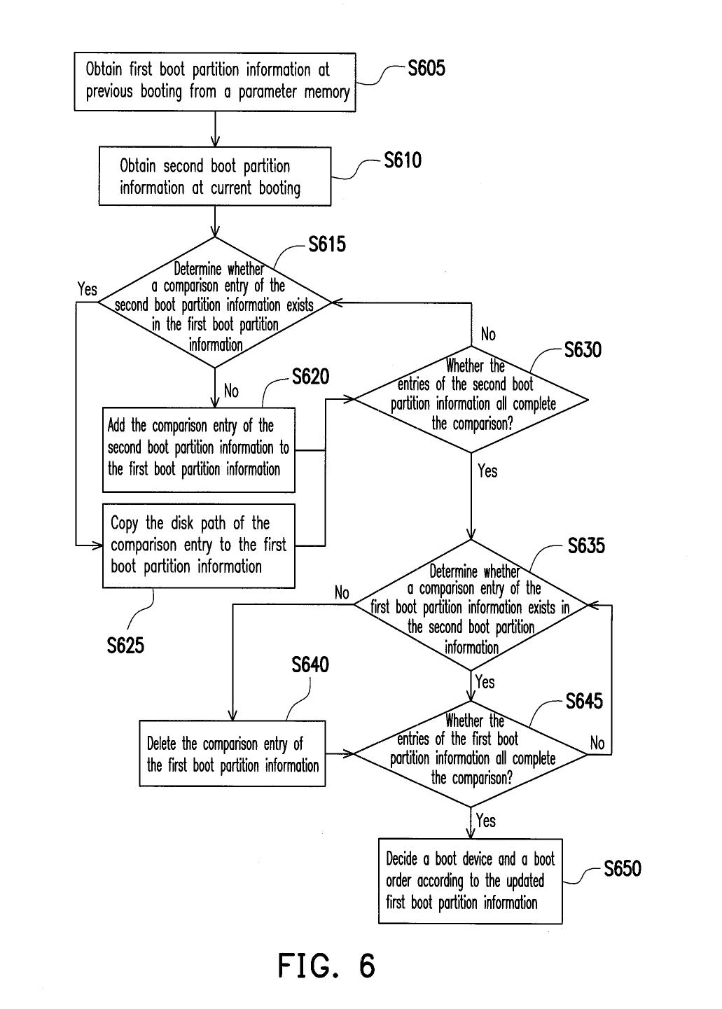

A further embodiment is illustrated below to describe how to find a changed entry (partition) in detail. FIG. 6 is a flow chart of a booting method according to another embodiment of the present invention. Referring to FIGS. 1 and 6, in step S605, during booting, the system firmware 151 obtains the first boot partition information recorded at the previous booting from the first boot device table 131 of the parameter memory 130. In step S610, the system firmware 151 obtains the second boot partition information at the current booting, stores the second boot partition information in the second boot device table 141 of the main memory 140, so as to compare the first boot partition information and the second boot partition information.

Thereafter, in step S615, it is determined whether a comparison entry of the second boot partition information exists in the first boot partition information. For example, one entry is taken from the first entry of the second boot partition information to the last entry thereof one by one as the comparison entry, so as to find whether an entry identical to the comparison entry exists in the first boot partition information. In other words, the partition ID, the disk ID, and the boot loader path of the comparison entry must be identical to those of one entry in the first boot partition information, and therefore, if the partition ID, the disk ID, and the boot loader path of the comparison entry are identical to those of one entry in the first boot partition information, it is determined that the comparison entry exists in the first boot partition information. As long as one of the partition ID, the disk ID, and the boot loader path is different, it is determined that the comparison entry does not exist in the first boot partition information.

If the system firmware 151 determines that the comparison entry does not exist in the first boot partition information, as shown in step S620, the comparison entry of the second boot partition information is added to the first boot partition information. If the system firmware 151 determines that the comparison entry exists in the first boot partition information, as shown in step S625, the disk path of the comparison entry is copied to the corresponding entry in the first boot partition information. Then, as shown in step S630, it is determined whether the entries of the second boot partition information all complete the comparison. If the comparison is not completed, step S615 is performed continuously. Therefore, the same disk connected at different positions in the electronic apparatus 100 is considered as the same disk.

After the comparison of the entries of the second boot partition information is completed, in step S635, it is determined whether a comparison entry of the first boot partition information exists in the second boot partition information. For example, one entry is taken from the first entry of the first boot partition information to the last entry thereof one by one as the comparison entry, so as to find whether an entry identical to the comparison entry exists in the second boot partition information. In other words, the partition ID, the disk ID, the disk path, and the boot loader path of the comparison entry must be identical to those of one of the entries in the first boot partition information at the same time, and therefore, if the four are identical, it is determined that the comparison entry exists in the first boot partition information. As long as one of the partition ID, the disk ID, the disk path, and the boot loader path is different, it is determined that the comparison entry does not exist in the first boot partition information.

If the system firmware 151 determines that the comparison entry does not exist in the second boot partition information, as shown in step S640, the comparison entry of the first boot partition information is deleted. Then, in step S645, it is determined whether the entries of the first boot partition information all complete the comparison. In another aspect, if the system firmware 151 determines that the comparison entry of the first boot partition information exists in the second boot partition information, step S645 is performed.

After the comparison of the entries of the first boot partition information is completed, in step S650, the system firmware 151 decides the boot device and the boot order according to the updated first boot partition information. For example, the boot loader table 153 and the updated first boot partition information are compared to update the boot device and the boot order. In other words, the boot loader path of each entry of the first boot partition information is compared to see whether the boot loader path exists in the boot loader table 153, so as to record the entries with the boot loader paths existing in the boot loader table 153 to the boot order.

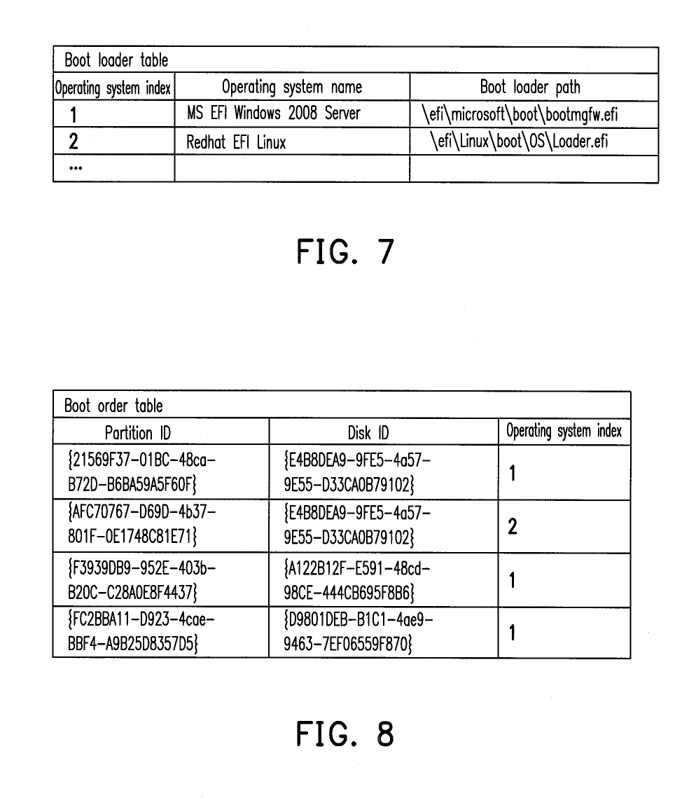

For example, FIG. 7 is a schematic view of a boot loader table according to an embodiment of the present invention. FIG. 8 is a schematic view of a boot order table according to an embodiment of the present invention. In FIG. 7, the boot loader table includes an operating system index field, an operating system name field, and a boot loader path field. In FIG. 8, the boot order table records the boot order, and includes a partition ID field, a disk ID field, and an operating system index field. Herein, the boot order table is stored in the main memory 140.

The boot loader path of each entry in the first boot partition information is compared in sequence to see whether the boot loader path exists in the boot loader table. If the boot loader path exists in the boot loader table, the partition ID and the disk ID of the entry are filled in the boot order table, and the operating system index corresponding to the boot loader path is filled in the boot order table. Thereafter, the entries of the boot order are converted to standard UEFI variables “Boot####” (#: 0-F) and “BootOrder”, in which the variable “Boot####” records devices that can be booted, and the variable “BootOrder” records the boot order.

In view of the above, the present invention compares the first boot partition information recorded at the previous booting and the second boot partition information obtained at the current booting, so as to update the first boot partition information with the changed entry, thereby updating the boot device and the boot order according to the first boot partition information. Therefore, any change of the hardware may be automatically detected and recorded, such that the user is aware of the change. In addition, the same disk connected to different positions in the electronic apparatus will not be considered as a different disk, but it is detected that the hardware configuration is changed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A booting method, applicable to an electronic apparatus, comprising:
obtaining first boot partition information of the electronic apparatus recorded at previous booting;
obtaining second boot partition information of the electronic apparatus at current booting, wherein the first boot partition information and the second boot partition information respectively comprise a plurality of entries corresponding to a plurality of partitions;
comparing the first boot partition information and the second boot partition information, so as to update the first boot partition information with a changed entry; and
deciding a boot device and a boot order according to the updated first boot partition information.

2. The booting method according to claim 1, wherein each of the entries comprises a partition identifier (ID), a disk ID, a disk path, and a boot loader path.

3. The booting method according to claim 2, wherein the step of comparing the first boot partition information and the second boot partition information so as to update the first boot partition information with the changed entry comprises:
comparing the entries of the second boot partition information one by one in terms of the partition ID, the disk ID, and the boot loader path to see whether the entries exist in the first boot partition information, comprising:
when the partition ID, the disk ID, and the boot loader path of a first comparison entry among the entries of the second boot partition information are all identical to those of one of the entries of the first boot partition information, determining that the first comparison entry of the second boot partition information exists in the first boot partition information; and
when one of the partition ID, the disk ID, and the boot loader path of the first comparison entry does not exist in the entries of the first boot partition information, determining that the first comparison entry of the second boot partition information does not exist in the first boot partition information, and adding the first comparison entry to the first boot partition information; and
comparing the entries of the first boot partition information one by one in terms of the partition ID, the disk ID, and the boot loader path to see whether the entries exist in the second boot partition information, comprising:
when the partition ID, the disk ID, the disk path, and the boot loader path of a second comparison entry among the entries of the first boot partition information are all identical to those of one of the entries of the second boot partition information, determining that the second comparison entry of the first boot partition information exists in the second boot partition information; and
when one of the partition ID, the disk ID, the disk path, and the boot loader path of the second comparison entry does not exist in the entries of the second boot partition information, determining that the second comparison entry of the first boot partition information does not exist in the second boot partition information, and deleting the second comparison entry from the first boot partition information.

4. The booting method according to claim 2, wherein the step of deciding the boot device and the boot order according to the updated first boot partition information comprises:
comparing a boot loader table and the updated first boot partition information, so as to update the boot device and the boot order, the step comprising:
comparing the boot loader path of each of the entries of the first boot partition information to see whether the boot loader path exists in the boot loader table; and
recording the entries with the boot loader paths existing in the boot loader table to the boot order in sequence.

5. The booting method according to claim 4, wherein the first boot partition information is stored in a parameter memory, the second boot partition information is stored in a main memory, and the boot loader table is stored in a system firmware memory.

6. An electronic apparatus, comprising:
a central processing unit (CPU);
a chip set, coupled to the CPU;
a parameter memory, coupled to the chip set, for storing a first boot device table, and recording first boot partition information of the electronic apparatus at previous booting by using the first boot device table;
a main memory, coupled to the chip set, for storing a second boot device table, and recording second boot partition information of the electronic apparatus at current booting by using the second boot device table; and
a system firmware memory, coupled to the chip set, for storing system firmware and a boot loader table;
wherein, the CPU compares the first boot partition information and the second boot partition information by using the system firmware, so as to update the first boot partition information with a changed entry; and decides a boot device and a boot order according to the boot loader table and the updated first boot partition information.

7. The electronic apparatus according to claim 6, wherein each of the entries comprises a partition identifier (ID), a disk ID, a disk path, and a boot loader path.

8. The electronic apparatus according to claim 7, wherein the system firmware compares the entries of the second boot partition information one by one in terms of the partition ID, the disk ID, and the boot loader path to see whether the entries exist in the first boot partition information; when the partition ID, the disk ID, and the boot loader path of a first comparison entry among the entries of the second boot partition information are all identical to those of one of the entries of the first boot partition information, the system firmware determines that the first comparison entry of the second boot partition information exists in the first boot partition information; when one of the partition ID, the disk ID, and the boot loader path of the first comparison entry does not exist in the entries of the first boot partition information, the system firmware determines that the first comparison entry of the second boot partition information does not exist in the first boot partition information; and when the system firmware determines that the first comparison entry does not exist in the first boot partition information, the system firmware adds the first comparison entry to the first boot partition information; and
the system firmware compares the entries of the first boot partition information one by one in terms of the partition ID, the disk ID, and the boot loader path to see whether the entries exist in the second boot partition information; when the partition ID, the disk ID, the disk path, and the boot loader path of a second comparison entry among the entries of the first boot partition information are all identical to those of one of the entries of the second boot partition information, the system firmware determines that the second comparison entry of the first boot partition information exists in the second boot partition information; when one of the partition ID, the disk ID, the disk path, and the boot loader path of the second comparison entry does not exist in the entries of the second boot partition information, the system firmware determines that the second comparison entry of the first boot partition information does not exist in the second boot partition information; and when the system firmware determines that the second comparison entry does not exist in the second boot partition information, the system firmware deletes the second comparison entry from the first boot partition information.

9. The electronic apparatus according to claim 6, wherein the system firmware compares a boot loader path of each of the entries of the first boot partition information to see whether the boot loader path exists in the boot loader table; and records the entries with the boot loader paths existing in the boot loader table to the boot order in sequence.

10. A booting method, applicable to an electronic apparatus, comprising:
obtaining first boot partition information of the electronic apparatus recorded at previous booting, wherein the first boot partition information is stored in a parameter memory;
obtaining second boot partition information of the electronic apparatus at current booting, wherein the first boot partition information and the second boot partition information respectively comprise a plurality of entries corresponding to a plurality of partitions, wherein each of the entries comprises a partition identifier (ID), a disk ID, a disk path, and a boot loader path wherein the second boot partition information is stored in a main memory;
comparing the first boot partition information and the second boot partition information, so as to update the first boot partition information with a changed entry, comprises:
comparing the entries of the second boot partition information one by one in terms of the partition ID, the disk ID, and the boot loader path to see whether the entries exist in the first boot partition information, the step comprising:
when the partition ID, the disk ID, and the boot loader path of a first comparison entry among the entries of the second boot partition information are all identical to those of one of the entries of the first boot partition information, determining that the first comparison entry of the second boot partition information exists in the first boot partition information; and
when one of the partition ID, the disk ID, and the boot loader path of the first comparison entry does not exist in the entries of the first boot partition information, determining that the first comparison entry of the second boot partition information does not exist in the first boot partition information, and adding the first comparison entry to the first boot partition information; and
comparing the entries of the first boot partition information one by one in terms of the partition ID, the disk ID, and the boot loader path to see whether the entries exist in the second boot partition information, the step comprising:
when the partition ID, the disk ID, the disk path, and the boot loader path of a second comparison entry among the entries of the first boot partition information are all identical to those of one of the entries of the second boot partition information, determining that the second comparison entry of the first boot partition information exists in the second boot partition information; and
when one of the partition ID, the disk ID, the disk path, and the boot loader path of the second comparison entry does not exist in the entries of the second boot partition information, determining that the second comparison entry of the first boot partition information does not exist in the second boot partition information, and deleting the second comparison entry from the first boot partition information; and
deciding a boot device and a boot order according to the updated first boot partition information, comprises:
comparing a boot loader table and the updated first boot partition information, so as to update the boot device and the boot order, wherein the boot loader table is stored in a system firmware memory, the step comprising:
comparing the boot loader path of each of the entries of the first boot partition information to see whether the boot loader path exists in the boot loader table; and
recording the entries with the boot loader paths existing in the boot loader table to the boot order in sequence.
